(19) United States
(12) Patent Application Publication
(10) Pub. No.: US 2016/0307127 A1
(43) Pub. Date: Oct. 20, 2016

(54) SPATIO-TEMPORAL CREW PLANNING

(71) Applicants: International Business Machines Corporation, Armonk, NY (US); DTE Electric Company, Detroit, MI (US)

(72) Inventors: Jeffrey S. Katz, West Hartford, CT (US); Ali Koc, White Plains, NY (US); Gerard Labut, Warren, MI (US); Richard J. Mueller, Troy, MI (US); Ashish Sabharwal, Seattle, WA (US); Amith Singhee, Bangalore (IN)

(21) Appl. No.: 15/080,656

(22) Filed: Mar. 25, 2016

Related U.S. Application Data
(60) Provisional application No. 62/147,002, filed on Apr. 14, 2015.

(51) Int. Cl. G06Q 10/06

(52) U.S. Cl. CPC G06Q 10/0633; G06Q 10/063112

(57) ABSTRACT

A method, system, and computer program product to perform infrastructure management include generating models of one or more work shifts, repair tasks, and safety tasks, each of the models including one or more variables, defining a constraint that affects at least one of the one of more variables of at least one of the models, and generating a scenario based on the models and the constraint. Solving for the one or more variables of each of the models of the scenario to determine resource pre-positioning and task scheduling, according to the scenario, is performed in order to perform the infrastructure management, the solving being based on achieving one or more objectives.

### DOMESTIC PRIORITY

This application is a non-provisional application that claims priority to U.S. Provisional Application Ser. No. 62/147,002 filed Apr. 14, 2015, the disclosure of which is incorporated by reference herein in its entirety.

### BACKGROUND

The present invention relates to infrastructure management, and more specifically, to spatio-temporal crew planning.

Different types of organizations have infrastructure distributed throughout their service regions. Exemplary organizations include electric and other utilities that have distributed equipment that may be networked together, communication networks, franchises with stand-alone outlets in various locations, and service and repair entities that maintain equipment located in individual homes or businesses. The resources (e.g., crew, equipment (including land, sea, or air vehicles), supplies) that are needed to repair and maintain the infrastructure are typically dispatched from a number of service centers distributed throughout the service regions. Currently, crew planning typically does not consider an estimation of restoration time and task scheduling is typically done for static resource capacities.

### SUMMARY

Embodiments include a method, system, and computer program product to perform infrastructure management. Aspects include generating, using a processor, models of one or more work shifts, repair tasks, and safety tasks, each of the models including one or more variables; defining a constraint that affects at least one of the one of more variables of at least one of the models; generating a scenario based on the models and the constraint; and solving, using the processor, for the one or more variables of each of the models of the scenario to determine resource pre-positioning and task scheduling, according to the scenario, in order to perform the infrastructure management, the solving being based on achieving one or more objectives.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a process flow of a method of managing infrastructure according to embodiments;

FIG. 2 illustrates an exemplary scenario and solution according to embodiments;

FIG. 3 illustrates another exemplary scenario and solution according to embodiments;

FIG. 4 is a process flow of a method of solving variables to generate scenarios and manage infrastructure according to an embodiment; and

FIG. 5 is a block diagram of a system according to embodiments of the invention.

### DETAILED DESCRIPTION

As noted above, managers of organizations that maintain distributed infrastructure and personnel typically have service centers from which resources are deployed for repair and maintenance of the infrastructure. The spatio-temporal prepositioning of these resources is a challenge because necessary resources must be allocated to the service centers with the most urgent need without creating more issues at other service centers by depriving them of their base resource needs. The prepositioning issue arises under two general situations—when tasks are already open because damage has occurred (e.g., storm damage has caused outages for a telecommunications network) or when tasks are forecast based on expected damage (e.g., a thunderstorm is predicted that could result in damage to a power utility network, and the number of damage tasks is predicted for each day in the next three days for each service region). Embodiments of the systems and methods detailed herein relate to resource planning and management that includes resizing and movement of resources while considering business constraints and organizational structures. Through the constraints, for example, the systems and methods can ensure that infrastructure in one area is not neglected due to an outage in another area while sufficient resources are provided to the outage area to address the urgent need. The embodiments include limiting the parameters that are modeled as variables and solved. For explanatory purposes, infrastructure management related to an electrical utility is discussed below. However, the embodiments discussed herein are not limited to the management of any particular type of infrastructure. For example, the embodiments apply, as well, to gas pipelines, water, and telecommunication networks, franchises or a set of businesses, or goods (e.g., appliances).

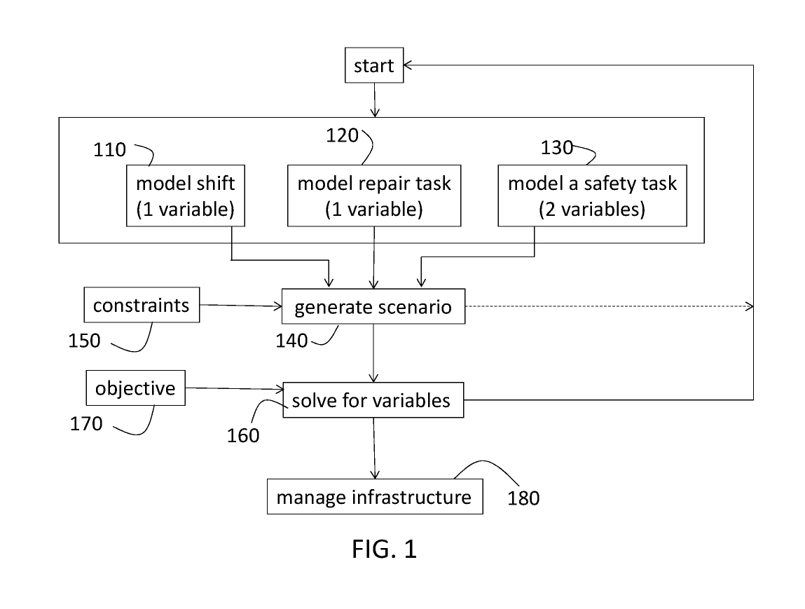

FIG. 1 is a process flow of a method of managing infrastructure according to embodiments. FIG. 1 shows the general flow, while specific exemplary embodiments are detailed below. The variables are modeled at blocks 110, 120 and 130. At block 110, modeling a shift refers to the work shift of a crew member. A shift may be defined as a single contiguous time range. A shift is modeled as an unmovable interval but with an associated movement variable. That is, a shift from 8 am to 5 pm has an interval (8 am to 5 pm) that may not be moved, but the associated movement variable allows that shift to be completed at different locations by the crew associated with that work shift, as needed. Modeling the shift (at block 110) may include considering different modes. For example, a crew may be limited to working a single 8-hour shift during a regular working day but may be permitted to work overtime up to 16 hours a day while in emergency mode. At block 120, modeling a repair task includes modeling a task with a fixed duration and a variable interval. That is, the amount of time (e.g., 5 hours) is fixed, but the variable associated with the repair task is the start and stop time or interval (e.g., 8 am to 1 pm, 2 am to 7 am). At block 130, modeling a safety task refers to a public safety task that may be associated with a repair. For example, in the exemplary case of a repair of a downed electrical wire, safety crew must be dedicated to that location until the repair is completed to ensure public safety. The interval (start and stop times) and duration are both variable in the case of a public safety task, because the task ends whenever the repair begins.

Generating a scenario, at block 140, includes using the model variables (from blocks 110, 120, and 130) as well as constraints from block 150. Exemplary scenarios are discussed below. Constraints may be received through user inputs and may be universal or situation-specific. The constraints defined at block 150 may include the condition that a public safety task precedes certain repair tasks and must remain active until the start of the repair task, for example. This may be an example of a universal constraint that always applies. The constraints may also include the consideration of different crew types. For example, while a regular crew may be preferable from a cost and logistics standpoint, some repairs (e.g., natural disaster affecting a large area) may require the use of contract crews or foreign crews (i.e., crews from other areas). Thus, this constraint may change based on the situation specific to the planning horizon. Similarly, specific types of tasks may require specific resources (including crews). The number of crews nominally available at any given location may be limited. The limit may be determined by factors such as the maximum number of employees reporting at that location, the day of the week, whether it is a holiday, the type of crew and time of day, for example. The constraints may specify that each task is associated with an estimated duration. Certain tasks may be specified as having chronological dependency. For example, when an energized wire is reported as being downed, a public safety resource may be required until the overhead line repair crew begins repair. A constraint may define a service center—different from the home service center of a regional crew—to which a crew may be assigned to decrease restoration time. Some crews may not be assigned to service centers at all. For example, foreign crews may be staged in temporary pullouts. That is, a staging location is any location (e.g., service center, pullout) where crews are staged for dispatch to tasks. While a work shift may be associated with a home staging location, the movement variable for a work shift means that the work shift may be completed at a different staging location. Generally, tasks are created for service centers. Thus, work is assigned to service centers and not to pullouts.

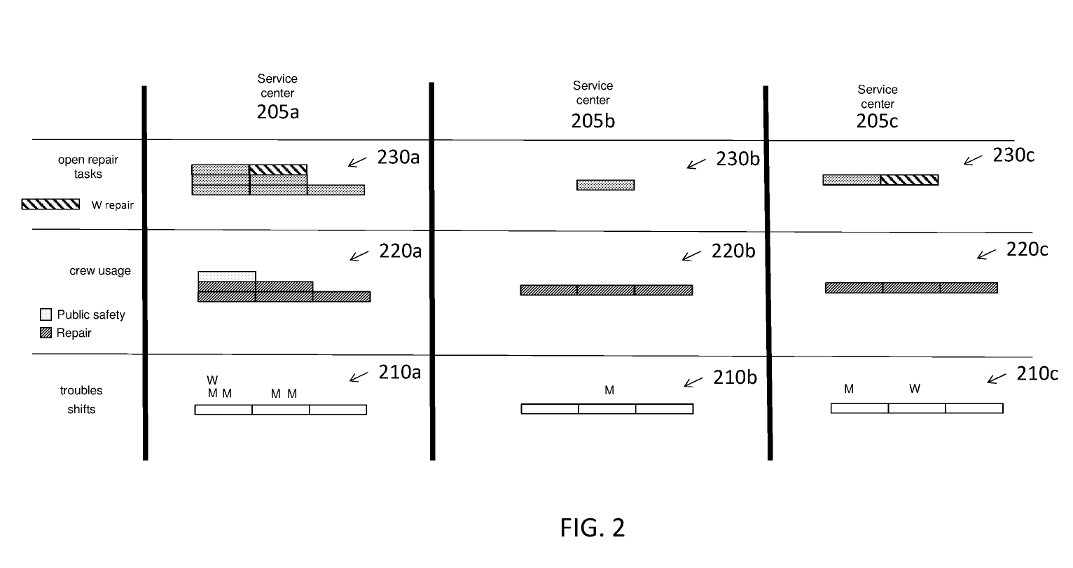

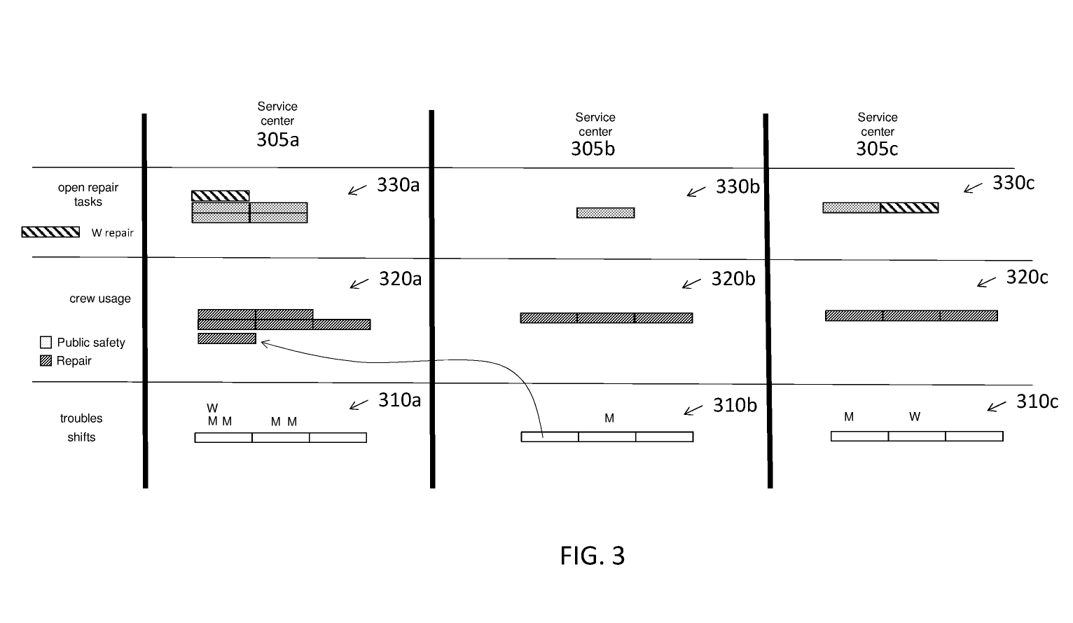

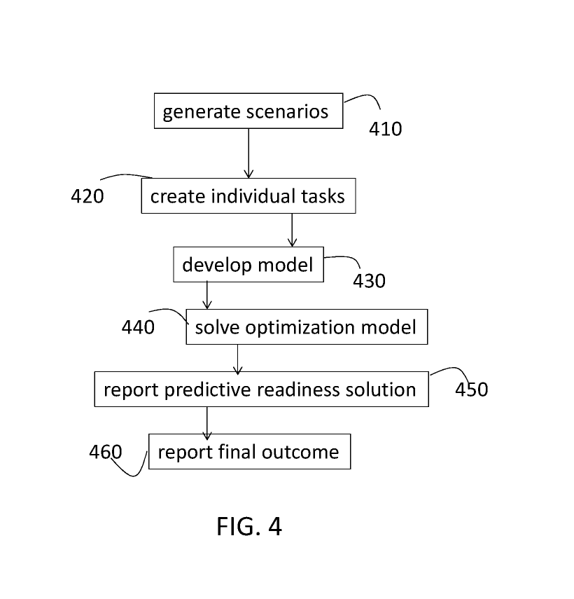

Solving the variables, at block 160, refers to solving the variables of the models used to generate the scenario (at block 140). The solving is based on one or more objectives, provided at block 170. Just as constraints (at block 150) impose features on the scenario (generated at block 140) that are additional to those provided by the models (at blocks 110, 120, 130), objectives (at block 170) impose goals on the solution (generated at block 160). That is, while the variables and constraints define a search space for a solution, the objectives define a specific set of values within the search space that are preferred. Thus, the objectives are affected by the scenario (i.e., objectives are not unchanged regardless of scenario). The objective or objectives at block 170 may include parameters that must be minimized (e.g., number of unallocated tasks, amount of time taken to resolve issues, number of crew movements, delay in starting any task, total number of crews used at any time, cost of crews used). The objectives at block 170 may be weighted such that solving, at block 160, involves solving a minimization function. Solving the variables of the models at block 160 includes assigning a start time to an open task with the constraint that the entire duration of the task lies within a work shift associated with a crew that has the crew type required by the task, and the work shift movement variable is assigned to the service center associated with the task. Solving may result in a task being left unallocated within the planning horizon. This may happen because of insufficient resources (e.g., crews) to complete all tasks, for example. In this case, the solution may include the start time of a task being set to a time after the end of the planning horizon. The processes at blocks 110 through 170 may be repeated to generate and solve for different scenarios, as indicated by FIG. 1. Thus, the processes at blocks 110 through 170 may be performed iteratively. Each time the processes are repeated, one or more models (at blocks 110, 120, 130) or one or more constraints (at block 150) may be changed. FIGS. 2 and 3 illustrate two different scenarios and related solutions. The discussion with reference to FIG. 4 relates to an embodiment (indicated by the dashed line) in which a number of scenarios (at block 140) are generated, and the order in which the scenarios are solved is selected to increase efficiency.

The constraints (at block 150) may change over the course of generating solutions (i.e., repeating the processes shown in FIG. 1). That is, as the processes converge on a solution (at block 160), movement of crews may become increasingly limited. This constraint may be referred to as search space pruning. That is, each iteration of generating a scenario (at block 140) and solving (at block 160) may benefit from the results of the previous solution. For example, crew movements to a location in any shift in which there were no unscheduled tasks in the previous solution may be forbidden (i.e., movement search space pruning may be performed). The solution (at block 160) solves the variables associated with a scenario (generated at block 140). The solution at block 160 (for the current scenario 140) may be improved by seeding each subsequent scenario and, thus, solution with the solution of the previously solved scenario. According to an alternate embodiment described with reference to FIG. 4, the solving (at block 160) may be made more efficient by generating all the scenarios (at block 140) first.

Managing the infrastructure, at block 180, includes selecting one of the scenarios generated at block 140 and implementing the related solution (solved at block 160). The scenario and associated solution that is ultimately selected for implementation may be based on the objectives and the weighting of the objectives. The objectives used to solve a scenario and manage infrastructure (at block 180) may be contradictory such that a trade-off is required. For example, one objective might be to minimize the number of crews, but this objective may be counter to the objective of maximizing the number of tasks completed. Another exemplary objective may relate to the cost of moving a crew. The cost may be quantified by a cost function. For example, the cost of moving a crew from a staging location to another location may be determined as the product of the travel time between the two locations and a scaling factor. Thus, solving a scenario involves a balancing of a number of objectives. Following the examples discussed with reference to FIGS. 2 and 3, an embodiment for solving the scenarios (generated at block 140) in order to manage the infrastructure (at block 180) are detailed below.

FIG. 2 illustrates an exemplary scenario and solution according to embodiments. The third row (labeled trouble shifts) illustrates the exemplary scenario while the other two rows illustrate the solution. Three staging locations (service centers 205a, 205b, and 205c) are shown with a maximum of two crews normally reporting to each. In the exemplary scenario shown in FIG. 2, the movement variables associated with work shifts are disabled. Thus, no movement of crews between service centers 205 is allowed. The scenario shown in FIG. 2 is generated with a constraint (at block 150) that every service center must have one crew, at a minimum, for each of three 8-hour shifts. Another constraint is that, when a trouble of type downed live wire (W) has occurred, a public safety crew is needed until the repair begins. Each service center 205a-205c is associated with trouble of various types in each of the three 8-hour shifts indicated by 210a-210c. Multi-customer outages are indicated by “M” and a live wire being down is indicated by “W” in each applicable shift. Thus, for example, for the first service center 205a, two multi-customer outages M and one live wire down W are indicated during the first shift, and two multi-customer outages M are indicated in the second shift. For the second service center 205b, one multi-customer outage is indicated in the second shift by 201b, and, for the third service center 205c, one multi-customer outage M is indicated in the first shift, and a live wire down W is indicated in the second shift by 210c. Crew usage at each service center 205a-205c is indicated by 220a-220c, respectively. Two crew types are indicated: a public safety crew type, and a repair crew type. The open repair tasks for each service center 205a-205c are indicated by 230a-230c, respectively. Because of the constraint that a public safety crew must be present until a repair begins for a live wire down W, the public safety crew is used during the first shift (220a) by service center 205a because the live wire down W is repaired during the second shift (as indicated by the striped rectangle, 230a). On the other hand, the live wire down W in the second shift (210c) at the third service center 205c is repaired during the second shift (230c). Thus, no public safety crew is needed during the exemplary three shifts shown for service center 205c. There are no open repairs during the first and third shifts (230b) at the second service center 205b and during the third shift (230c) at the third service center 205c. However, because movement of crews between service centers 205 is disallowed, the crew from the first shift at the second service center 205b cannot be used by the first service center 205a to repair the live wire down W during the first shift, thereby saving the use of the public safety crew, for example.

FIG. 3 illustrates another exemplary scenario according to embodiments. The same troubles (310a-310c) are assumed with regard to the current scenario as for the scenario shown in FIG. 2. Thus, FIG. 3 represents the results of another iteration of the processes shown in FIG. 1. Once again, the exemplary scenario is illustrated by the third row, while the solution is illustrated by the first two rows. Crew usage 320a, 320b, 320c for each service center 305a, 305b, 305c associated with each open repair task 330a, 330b, 330c based on the trouble indicated per shift 310a, 310b, 310c is shown. However, the scenario shown in FIG. 3 differs from that shown in FIG. 2 in that crew movement between service centers 305 is allowed. That is, the movement variables associated with work shifts are enabled, as indicated by the crew usage 320a, for example. As a result, a first shift crew from the second service center 205b may be moved to the first service center 205a. By adding this crew to the first service center 205a, in addition to the two regular crews of that service center 205a, the live wire down W repair may be handled during the first shift (as indicated by the stripped rectangle, 330a). Consequently, a public safety crew is not needed at the first service center 205a to await the start of repair of the live wire down W during the second shift (as it was in the scenario of FIG. 2, as indicated by 220a).

As FIG. 1 indicates, constraints (block 150) imposed on the scenarios (at block 140) affect the solutions that are generated (block 160). This is apparent from a comparison of the exemplary scenarios shown in FIGS. 2 and 3. The change in constraint from disallowing crew movement between service centers 205 (FIG. 2) to allowing crew movement between service centers 305 (FIG. 3) results in no longer needing a public safety crew in the scenario shown in FIG. 3, for example. Scenarios can differ in the constraints they impose on the availability and usage of resources by type or by origin. The availability of resources may be adjusted based on a mode of operation (e.g., total work hours per day may be adjusted based on normal or emergency modes of operation) that is defined by the responding organization. In the above example, two scenarios result from restricting crew movement between service centers 205 (according to one scenario) and allowing crew movement between service centers 305 (according to another scenario). These exemplary scenarios are indicative of tradeoffs that can result. For example, enabling crew movement may increase one aspect of operational cost but reduce the overall restoration time. Similarly, adding in more crews by enabling the use of contract or foreign crews may increase cost but reduce restoration time.

Scenarios may also be generated to capture stochasticity in the prediction of tasks. As noted above, planning may address damage that is already done or damage that is predicted. Thus, when damage is predicted, scenarios may be based on the expected extent of impact of various types of trouble or on certain low or high quantiles of the predicted extent. The extent of impact of a certain type of trouble is expressed as a numerical or categorical value that can be mapped to a resource requirement. As an example, a scenario may have the number of tasks corresponding to the 5^{th} percentile of the predicted distribution of tasks, while a different scenario may have the number of tasks corresponding to the 95^{th} percentile.

FIG. 4 is a process flow of a method of solving variables (block 160) for different scenarios (block 140) to manage infrastructure (at block 180) according to an embodiment. At block 410, generating a number of possible scenarios is performed. This refers to iteratively performing processes 110 through 140 in FIG. 1. As noted above, iteratively solving for variables of one scenario may be seeded with the solution for a previous scenario. This re-use of the solution from one scenario for another is detailed below with an example outlined in Table 1:

TABLE 1
Exemplary scenario re-use variables.

| | |
|---|---|
| S and T | two scenarios |
| U | set of tasks common between scenarios S |
| | and T |
| V | crew shift availability that is common |
| | between scenarios S and T |
| M | set of movements that can be implemented |
| | for the common crew shift availability V |
| R | crew availability resulting from application |
| | of movements M to crew shift availability V |

The task schedule from scenario T that satisfies U (common tasks) and R (crew availability) is a starting point for scenario S. The scenarios may be solved in order of generalization when it applies. That is, for the two exemplary scenarios S and T, the relation “S generalizes T” or GEN(S,T) holds when scenario S represents at least as many open tasks of each type as scenario T at any time in the planning horizon, and the resources available in scenario S are no fewer than those available in scenario T at any time (i.e., number of open tasks of S≧T and number of resources in S≧T). When these conditions are true, then the scenario S is generally a computationally harder problem than scenario T. Further, any solution to scenario T (soln_{T}) is also a (possibly sub-optimal) solution to scenario S, and soln_{T} may be used to make the search for an optimal solution to scenario S faster. That is, soln_{T} represents a better starting point for solving scenario S than a default starting point.

Creating individual tasks, at block 420, is done for each scenario S generated at block 410. The individual tasks must capture the response needed to address the impact of the trouble. Each task is associated with a resource requirement (resource type and number) and an estimated completion duration. The duration may be a function of how many resources are deployed. The tasks may have temporal dependencies on each other. An example of this is the public safety task that must precede a type of repair task. Each task may have a priority, an earliest start time, and a latest completion time associated with it. Developing a model, at block 430, includes capturing, for each scenario S in a constrained optimization model M(S), the desired planning time horizon, resource utilization constraints of the scenario, the organization's operational constraints, the tasks (from block 420), and the desired objective function. According to an embodiment, the proposed model M(S) is a constraint programming (CP) model for capacity scheduling. The CP model works at the level of the number of resources of each type available at any point in time rather than individual resource elements to ensure that a solution is not reached that requires more resources than are available. For each resource type, a model variable captures a time series of the usage for that resource type at any point in time. A constraint ensures that this time series does not exceed the availability of that resource type at any time point. The model M(S) includes other operational constraints such as, for example, the maximum number of continuous working hours and travel time for a crew, and appropriate matching of resource type to each task. In sum, the model M(S) captures, as constraints, all the information from the models (110, 120, 130) and constraints (150) that was used to generate the scenario, as well as the objectives (170).

Solving the associated CP model for each scenario S, at block 440, provides a complete schedule of tasks along with a goodness measure in the form of the value of the objective function. The set of CP models associated with the scenarios generated (according to block 140) at block 410 may be solved in one of two ways. According to an independent approach, all CP models (associated with all scenarios S) are solved (at block 160) independently, either sequentially or in parallel. The independent approach is amenable to exploiting full scenario parallelism. According to a partial order approach, the order of generalization is used, as noted in the discussion of block 410. For each scenario S, the set of scenarios T are identified such that GEN(S,T) holds. For each such scenario T, all or a subset of the CP models M(T) are solved, and the best solution is used to seed the search for the solution for M(S). This use of seed solutions for harder scenarios can make the search for an optimal solution significantly faster.

At block 450, reporting a predictive readiness solution includes extracting, for each scenario S, the pre-positioning aspect from the complete schedule for M(S) (at block 440). When the complete schedule for M(S) is optimal, so is the pre-positioning aspect. If, rather than the complete schedule, only the optimal resource allocation and positioning is computed for Day 1 of an extreme event, for example, then the resulting overall response may be provably sub-optimal. At block 460, reporting the final outcome includes reporting a best-found or a Pareto frontier of optimal resource pre-positioning plan and the associated response goodness metrics for all scenarios generated (according to block 140) at block 410. Pareto efficiency is a known state of allocation of resources, and a Pareto frontier is a set of parameterizations (allocations) that are all Pareto efficient. Thus, the final outcome reported at block 460 includes only the set of plans that are feasible such that tradeoffs among the set may be considered to ultimately manage infrastructure (block 180, FIG. 1).

The solution approach discussed with reference to FIG. 4 may be extended to directly incorporate impact prediction stochasticity through a stochastic constraint programming model in which whether a task is active or not is a stochastic variable. Additionally or alternately, the solution approach discussed with reference to block 440 may be extended to directly incorporate response uncertainty through a stochastic constraint programming model in which the resource requirement and duration are stochastic variables.

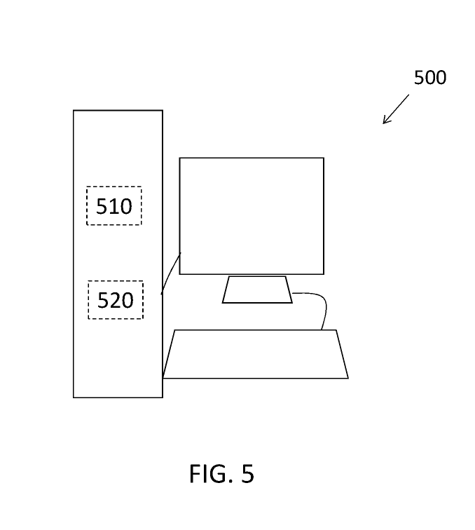

FIG. 5 is a block diagram of a system 500 according to embodiments of the invention. The system 500 includes one or more memory devices 510 and one or more processors 520. The system 500 includes additional known components that perform functions such as, for example, obtaining inputs, communicating with other systems of one or more service centers, and providing outputs. The system 500 may be repeated at each service center or may be a central system that communicates with other systems at each service center. The one or more processors 520 may be used in the infrastructure management (block 180, FIG. 1) based on communicating with other systems of the service centers or providing outputs, as well as in scenario generation (block 140, FIG. 1) and solving (block 160, FIG. 1). The one or more memory devices 510 store instructions implemented by the processor 520. These instructions include processes used to perform the infrastructure management according to embodiments discussed herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method of performing infrastructure management, the method comprising:
generating, using a processor, models of one or more work shifts, repair tasks, and safety tasks, each of the models including one or more variables;
defining a constraint that affects at least one of the one of more variables of at least one of the models;
generating a scenario based on the models and the constraint; and
solving, using the processor, for the one or more variables of each of the models of the scenario to determine resource pre-positioning and task scheduling, according to the scenario, in order to perform the infrastructure management, the solving being based on achieving one or more objectives.

2. The computer-implemented method according to claim 1, wherein the generating the models includes generating each work shift model with a fixed duration and a variable location.

3. The computer-implemented method according to claim 1, wherein the generating the models includes generating each repair task model with a fixed duration and a variable time interval.

4. The computer-implemented method according to claim 1, wherein the generating the models includes generating each safety task model with a variable time interval and variable duration.

5. The computer-implemented method according to claim 1, wherein the solving for the one or more variables of the scenario includes generating a constrained optimization model, the constrained optimization model being a constraint programming model that ensures that a solution does not require more resources than are available according to the scenario, and the generating the constrained optimization model is according to the one or more objectives.

6. The computer-implemented method according to claim 5, wherein the generating the constrained optimization model according to the one or more objectives includes generating the constrained optimization model to minimize a number of unallocated tasks, a total cost of crew movements, a total time to complete allocated tasks, delay in starting any task, total number of crews used at any time, or cost of crews used.

7. The computer-implemented method according to claim 5, further comprising performing the generating the models and the generating the scenario two or more times to obtain two or more scenarios prior to performing the solving, wherein the solving the one or more variables of each of the models corresponding to each of the two or more scenarios includes determining an order of the solving based on whether one of the two or more scenarios generalizes another of the two or more scenarios, the one of the one or more scenarios generalizing the another of the two or more scenarios based on a number of open tasks and a number of resources of the one of the two or more scenarios being greater than or equal to the number of open tasks and the number of resources of the another of the two or more scenarios.

8. The computer-implemented method according to claim 7, further comprising extracting the resource pre-positioning and the task scheduling based on the solving the one or more variables of each of the models corresponding to each of the two or more scenarios.

9. A system to perform infrastructure management, the system comprising:
a memory device configured to store models of one or more work shifts, repair tasks, and safety tasks, each of the models including one or more variables; and
a processor configured to receive a constraint that affects at least one of the one of more variables of at least one of the models, generate a scenario based on the models and the constraint, and solve for the one or more variables of the models of the scenario to determine resource pre-positioning and task scheduling to achieve one or more objectives, according to the scenario, in order to perform the infrastructure management.

10. The system according to claim 9, wherein the models of the one or more work shifts include each work shift model having a fixed duration and a variable location.

11. The system according to claim 9, wherein the models of the repair tasks include each repair task model having a fixed duration and a variable time interval.

12. The system according to claim 9, wherein the models of the safety tasks include each safety task model having a variable time interval and variable duration.

13. The system according to claim 9, wherein the processor solves for the one or more variables of the scenario by generating a constrained optimization model, the constrained optimization model being a constraint programming model that ensures that a solution does not require more resources than are available according to the scenario, and the constrained optimization model being generated according to the one or more objectives which include minimizing a number of unallocated tasks, a total cost of crew movements, a total time to complete allocated tasks, delay in starting any task, total number of crews used at any time, or cost of crews used.

14. The system according to claim 13, wherein the processor generates the models and the scenario two or more times to obtain two or more scenarios prior to solving the one or more variables associated with each of the scenarios, and solves the one or more variables of each of the models corresponding to each of the two or more scenarios by determining an order in which to solve based on whether one of the two or more scenarios generalizes another of the two or more scenarios, the one of the one or more scenarios generalizing the another of the two or more scenarios based on a number of open tasks and a number of resources of the one of the two or more scenarios being greater than or equal to the number of open tasks and the number of resources of the another of the two or more scenarios.

15. The system according to claim 14, wherein the processor extracts the resource pre-positioning and the task scheduling based on solving the one or more variables of each of the models corresponding to each of the two or more scenarios.

16. A computer program product for performing infrastructure management, the computer program product comprising a computer readable storage medium having program instructions embodied therewith, the program instructions executable by a processor to perform a method comprising:
generating models of one or more work shifts, repair tasks, and safety tasks, each of the models including one or more variables;
receiving a constraint that affects at least one of the one of more variables of at least one of the models;
generating a scenario based on the models and the constraint; and
solving for the one or more variables of each of the models of the scenario to determine resource pre-positioning and task scheduling, according to the scenario, in order to perform the infrastructure management, the solving being based on achieving one or more objectives.

17. The computer program product according to claim 16, wherein the generating the models includes generating each work shift model with a fixed duration and a variable location, generating each repair task model with a fixed duration and a variable time interval, and generating each safety task model with a variable time interval and variable duration.

18. The computer program product according to claim 16, wherein the solving for the one or more variables of the scenario includes generating a constrained optimization model, the constrained optimization model being a constraint programming model that ensures that a solution does not require more resources than are available according to the scenario, and the generating the constrained optimization model is according to the one or more objectives that include minimizing a number of unallocated tasks, a total cost of crew movements, a total time to complete allocated tasks, delay in starting any task, total number of crews used at any time, or cost of crews used.

19. The computer program product according to claim 18, further comprising performing the generating the models and the generating the scenario two or more times to obtain two or more scenarios prior to performing the solving, wherein the solving the one or more variables of each of the models corresponding to each of the two or more scenarios includes determining an order of the solving based on whether one of the two or more scenarios generalizes another of the two or more scenarios, the one of the one or more scenarios generalizing the another of the two or more scenarios based on a number of open tasks and a number of resources of the one of the two or more scenarios being greater than or equal to the number of open tasks and the number of resources of the another of the two or more scenarios.

20. The computer program product according to claim 19, further comprising extracting the resource pre-positioning and the task scheduling based on the solving the one or more variables of each of the models corresponding to each of the two or more scenarios.
